(19) United States
(12) Patent Application Publication
(10) Pub. No.: US 2003/0236763 A1
(43) Pub. Date: Dec. 25, 2003

(54) Electronic message filing system

(76) Inventor: Alan Kilduff, Greystones (IE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/179,722

(22) Filed: Jun. 25, 2002

(51) Int. Cl. G06F 17/30

(52) U.S. Cl. 707/1

(57) ABSTRACT

An electronic message filing system An electronic message filing system and method is described. All messages created or received are associated with a specific message identifier and that identifier is then used to link all messages emanating or related to the first message. By additionally associating that identifier with a specific storage location it is possible to effectively associate multiple messages with one another and to file them efficiently.

### FIELD OF THE INVENTION

The invention relates to electronic messages and in particular to system and method for effecting an efficient filing of messages for subsequent search and retrieval. Within the present specification the term “electronic message” is intended to cover all types of electronic data messages which are transmitted over a network between two or more users including but not limited to e-mails, telecom type messages including SMS messages and the like.

### BACKGROUND OF THE INVENTION

With the growth of mobile telecommunications and the facility provided to users to utilise electronic communications such as e-mail and the like there has been an explosion in the use of such communication modes. E-mail has been adopted by most business and personal users as a preferential mode of communication. In order to enable an efficient utilisation of such e-mail communications it is advantageous to enable the user to group and file related messages together.

Typically all e-mails arrive in the user's “inbox” where they are maintained until the user has read the message and then decides whether to store them for subsequent retrieval or archival purposes or whether to delete them immediately. Some e-mail client user interfaces, such as PC based software or web interfaces to a web based e-mail provider, provide for the creation of rules relating to specific e-mail types such as bulk mails, mails from a specific sender etc., and provide for the immediate placement of those e-mails, not in the “inbox” but rather in a specific folder created for those messages. For those messages that do not fall within the parameters or the predefined rules the incoming message is typically left in the “inbox”. Most e-mail client user interfaces enable a sort and filing facility using common filing techniques such as enabling the creation of folders where the user can subsequently file those mails that are related. Typically, this is done on a top level type filing structure, using for example different project or recipients' names as folder names and filing all e-mails relating to that project or recipient in the specific folder. Once the user has decided that a message in the “inbox” is important or may be required at a later date he can then decide to file the message in an appropriate folder. This may cause difficulty if one exchanges e-mails relating to different subjects or matters with the one user.

One solution to this is to provide for a ranking or sorting of related e-mails by sender/subject etc.. This however requires each of the sender/recipient to implement a unique subject field for each message thread. Furthermore, all this filing requires the user to actively update the inbox, creating folders where appropriate and filing the messages in those folders at regular intervals. It further requires the user to remember which is the correct folder for placing or moving that specific message.

There is therefore a requirement for an improved messaging filing system.

### OBJECT OF THE INVENTION

It is an object of the present invention to provide a message filing system adapted to enable an efficient filing, grouping and retrieval of electronic messages.

### SUMMARY OF THE INVENTION

Accordingly the present invention provides an electronic message filing system which enables a grouping and threading of messages together, the grouping being effected based on the original message. The present invention provides for the association with an electronic message of a message specific identifier which can be used to subsequently trace and arrange messages related to that original message. Desirably, an association between the message specific identifier and a storage location is additionally provided.

In accordance with a preferred embodiment, an electronic message filing system adapted to interface to a messaging system is provided. The filing system incorporates a datastore having a first set of records and a second set of records, each record in the first set being associatable with a specific message identifier, and each corresponding record in the second set providing a location for storage of messages having that message identifier. By providing such an association between identifiers and storage locations, messages received at the messaging system can be interrogated to ascertain a correct location for storing that message. This is advantageous in that it enables an efficient filing and organisation of electronic messages.

The system may additionally include an identifier creation module, the identifier creation module adapted to effect the creation of a message specific identifier for association with any message that does not have an identifier previously associated therewith.

The identifier creation module desirably effects the creation of a message specific identifier for any new message created using the messaging system.

The identifier creation module may additionally effect the creation of a message specific identifier for any message received at the messaging system not having an identifier associated therewith.

The message identifier created for a specific message is desirably created using parameters definable by the characteristics of the created message. The identifier is typically defined by the user and the time/date of creation of the message.

The system may further include a search interface adapted to enable a search of all received messages such that any message received at the messaging system not having an identifier associated therewith can be associated with a message and/or location previously received from that sender.

Messages created from a message having an identifier are also desirably also associated with that same identifier.

The records in the second dataset desirably provide an indicator of location of stored messages having specific identifiers.

The invention also desirably provides a method of effecting a filing of one or more linkable electronic messages, the method comprising the steps of:

providing a first message with an identifier specifically associated with that message,

storing that identifier in a first set of records in a datastore,

linking that stored identifier with an address for a specific storage location for that first message,

associating any subsequent message related to that first message with the same identifier,

providing for the filing of the first and subsequent messages in the specific storage location linked to the stored identifier.

The method may further comprise the steps, upon receiving a message not having an identifier associated therewith, of:

creating a message specific identifier for that message on determination that no identifier is associated therewith,

storing the identifier for the received message with the first set of records in the datastore,

associating that identifier with a file location.

The message specific identifier created for the received message is desirably created using parameters defined by the composition of that message.

The step of associating that identifier with a file location desirably comprises the step of:

searching received messages for a previously received message from the sender, and on finding the last received and filed message from that sender offering the storage location of that last received message as a storage location for the recently received message.

The method may include the additional steps, on receiving a message having an identifier associated therewith, of:

searching for previously stored messages having that identifier,

on identification of previously stored messages, determining a file location for those messages, and

effecting a prompting of the user to file the received message in that file location.

The method may further comprise the steps on a subsequent moving of a message from one location to another location, of:

determining whether additional messages sharing the same identifier with the moved message are to be moved,

if, all messages sharing the same identifier are to be moved, updating the file location for all messages having that identifier, or else

if all messages sharing the same identifier are not to be moved, creating a new identifier for the moved message such that the moved message is no longer associated with the previous messages.

These and other features of the present invention will be better understood with reference to the following drawings.

### BRIEF DESCRIPTION OF THE DRAWINGS

FIG. 1 is a schematic of a system according to the present invention,

FIG. 2 is a process flow identifying some steps associated with the creation of a message according to the present invention,

FIG. 3 is a process flow showing the receipt and filing of a message according to the present invention,

FIG. 4 is a process flow showing the moving of a message according to the present invention, and

FIG. 5 shows an example of an implementation of the system of FIG. 1 into a network architecture.

### DETAILED DESCRIPTION OF THE DRAWINGS

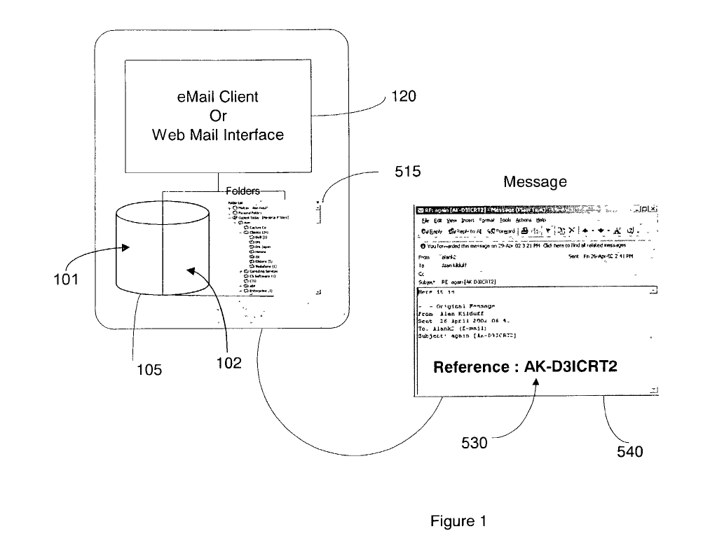

The system of the present invention provides a method of stamping or embedding e-mail messages with a reference identifier specifically associated with that message. This message identifier, as well as being associated with the originating message, is also maintained and associated with all subsequent messages relating to that originating message so as to enable a tracking of all related messages. Typically the identifier is also associatable with a record of the location of where the message is stored. As shown in FIG. 1, the present invention provides a message filing system incorporating an interrogatable database 105, or other datastructure, which includes at least two linkable record stores 101, 102. The first record store 101 is desirably associated with a specific message 540 or sequence of messages, whereas the second 102 is a pointer or linking field providing a location 515 for a preferential storing of that message. The records contained or storeable within the first datastore are desirably message identifiers 530 specifically associated with individual messages 540. This database 105 is desirably interfaceable with conventional messaging software packages 120 such that the datastore 105 can be provided as add-on functional software for typical electronic messaging systems such as those manufactured and provided by Microsoft™, Lotus™, Netscape™, Yahoo™, Hotmail™ and the like. It will also be appreciated that the functionality of the present invention could also be integrally built into such client interface packages. It will be further appreciated that the present invention has application in other non e-mail specific environments, such as for example the filing of SMS type messages in a mobile telephone handset or PDA.

By providing for the association of a message with a message identifier, and the additional association of that identifier with a file storage location, the system of the present invention provides for the linking of messages with previous messages that share the same identifier. The provision of an identifier which is specific to a message and message sequence provides for a convenient manner to file and retrieve related correspondence.

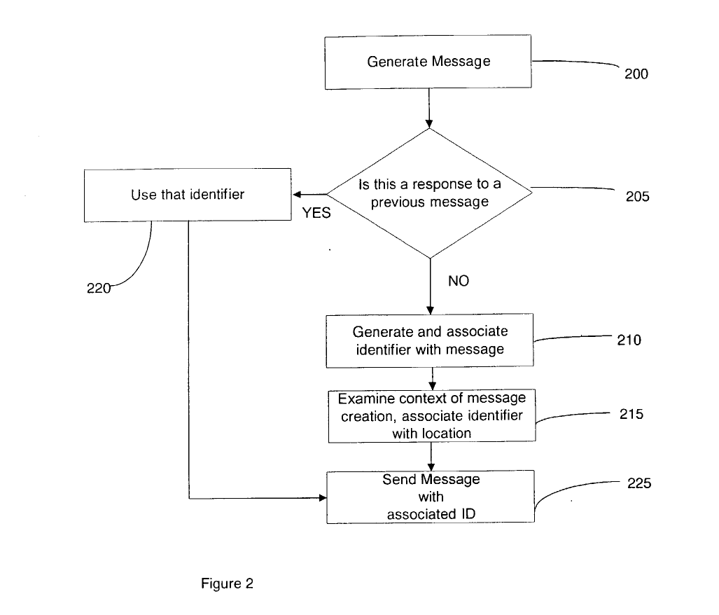

In order to effectively associate messages with identifiers it is necessary to provide an efficient manner to generate identifiers for messages and to subsequently use that identifier for that message and messages forming part of a message flow originating from that original message. FIG. 2 shows a process flow associated with an association of a message identifier with a specific message. An electronic message is generated in accordance with standard implementations (Step 200). In the example of the application of the present invention in an e-mail environment this is typically effected using the “compose” or “new message” functionality of the e-mail client user interface, although it will be appreciated that this generation functionality may differ depending on the type of electronic message being generated.

Once the message has been generated, the system is adapted to confirm whether the message generated is previously associated with a message identifier (Step 205). In the scenario of generating a new message, which is not in, response to a previous message, it will be necessary to provide a new identifier for that message (Step 210). Where the message is created to forward or reply to an existing message there will already be an identifier associated with the previous message and that identifier will also be associated with that new message. The identifier is generated in accordance with predefined rules which may be implemented by an administrator or other “super user” as will be apparent to those skilled in the art.

In a preferred implementation the reference identifier is an alpha numeric string created by calculating a cyclic redundancy check (CRC) on a larger string which is made up of the user's e-mail address and the current time. This alphanumeric string typically includes up to 3 letters which are the initials of the user who created the message, although as will be appreciated by those skilled in the art such an implementation is exemplary of the type of identifier that may be used and it is not intended to limit the application of the present invention to any one specific implementation of example of such.

Typically, when the system generates the identifier it checks a local storage subsystem to see if that reference has already been used. If it does find that it has been used, it again generates a new reference (now based on a new time) and tries again until it has a reference that has not been used before on this system. While this identifier is not guaranteed to be unique, there is a very low probability (in the order on 1 in several billion) of two identical reference identifiers being created within the system or between communicating parties.

By associating a reference identifier with a specific message, and using that for a sequence of messages originating from that message, the present invention provides for a better sorting/inventory of messages than was hereinbefore possible.

If the message was generated in response to a previous message which did have a message identifier associated with it, then the invention is adapted to utilise that identifier for association with the new message (Step 220). This identifier, it will be appreciated, is then a shared reference identifier between two or more messages and may be used at a later date to combine or thread messages sharing the same identifier. It may also be used to provide for an improved graphical representation of the location of stored messages.

Once a message has had an identifier associated with it, the system may examine the context of the message creation, for example, is the message created in a specific folder location? If the message has been created in such a specific context the system may associate the location of that context with the identifier such that the new identifier is now linkable to a storage location. The message, with associated identifier (ID), is then in a condition to be sent (Step 215), which again is implemented using the standard techniques of conventional message software applications.

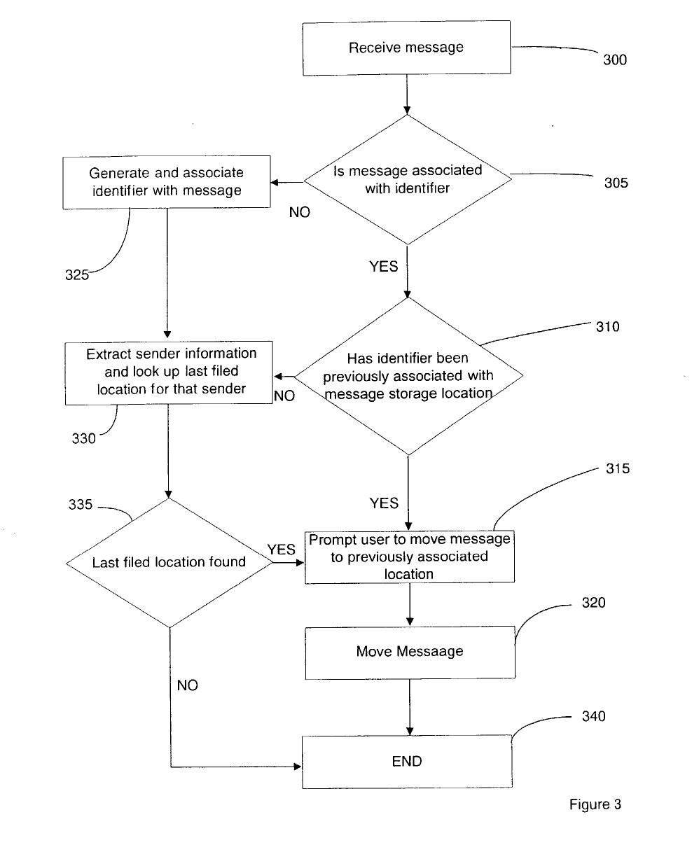

FIG. 3 shows an application of the present invention when implemented for receipt of a new message. On receipt of a message (Step 300) at the client user interface, but prior to display for the user, the message is examined to ascertain whether an identifier is associated with the message (Step 305). If an identifier is present, the local datastore is examined to ascertain whether any specific location for messages having that identifier is provided (Step 310). On determination that both an identifier and a location for that identifier are present, the message will be displayed for the user and the user will be prompted to move the message to the predefined location (Step 315). On receiving confirmation from the user that it is in order to effect the movement, the message is filed in that previously defined location (Step 320).

If, however, on examination of the message the system ascertains that there is no identifier associated with the message, the system generates an identifier for that message (Step 325). As the message was not created by the user who received the message, the identifier will be created based on the parameters associated with the sender of the message. These parameters are typically the same rule sequence that is used for generating an identifier locally created. The identifier will be linkable to the time of creation of the message and the initials of the sender. By basing the identifier on the sender criteria, the system provides for a minimisation of creation of duplicate identifiers for messages. For example if the sender had sent the message to two or more persons, none of whom had previously received a message having that identifier but both effecting the filing system of the present invention, the system of the present invention provides for the creation of the same identifier by both recipients for that message, thus obviating any duplication of identifiers in subsequent messages sequences.

If no location has been defined for or linked to an identifier, which may arise if the identifier is newly created or this is the first time that a message with that identifier has been received locally, the system is adapted to search for the last message received from that specific sender so as to ascertain where that last message was stored (Step 330). If a message from that sender is found (Step 335), then that location is offered to the user as a possible storage location (Step 315). If no previous message was received from the specific sender, or no location was specified for a previous message sent, then the process sequence ends (Step 340).

It will be appreciated that if messages which are resulting from messages which were originally generated by the local system are received into the system, the reference number will be found in the local storage subsystem and the incoming message will be associated with the associated location (folder) that the user had selected when originally creating the message. The message may be moved automatically to this folder if the user has explicitly directed the system to do so. Otherwise the message is moved to the appropriate folder when the user chooses to file it.

The reference number or identifier provided by the present invention may be used within the system of the present invention to:

1. Group and thread all the messages together that relate to the original message.

2. Enable the system to optionally automatically file the messages in the associated location (folder).

3. Enable the user to quickly file subsequent and related messages in the associated location (folder).

4. Enable the user to identify particular messages.

5. Enable the user to quickly search for, or retrieve, particular messages based on their reference identifier.

6. Provide for an improved visual display of messages within the client user interface.

The system works by generating a reference identifier on creating new messages or receiving messages not having identifiers already set. It will be appreciated that the reference identifier can be associated with specific messages in one of a plurality of different manners; for example the reference identifier can be appended to the subject line of the electronic message, appended to the body of the electronic message, or added as a custom field to the electronic message.

Once the message has been appended or associated with a specific message it is then necessary to store the reference identifier in a local storage subsystem (database or similar) along with a reference to the associated location (folder) in which to store the original message (optional) and all related messages that contain this reference identifier. This location (folder) may be selected by the user when they create the message or may be deduced by the system from the context in which the user created the message. For example if the user created the message from a specific folder, the system is adapted to provide a default location for all messages having that shared identifier of that location.

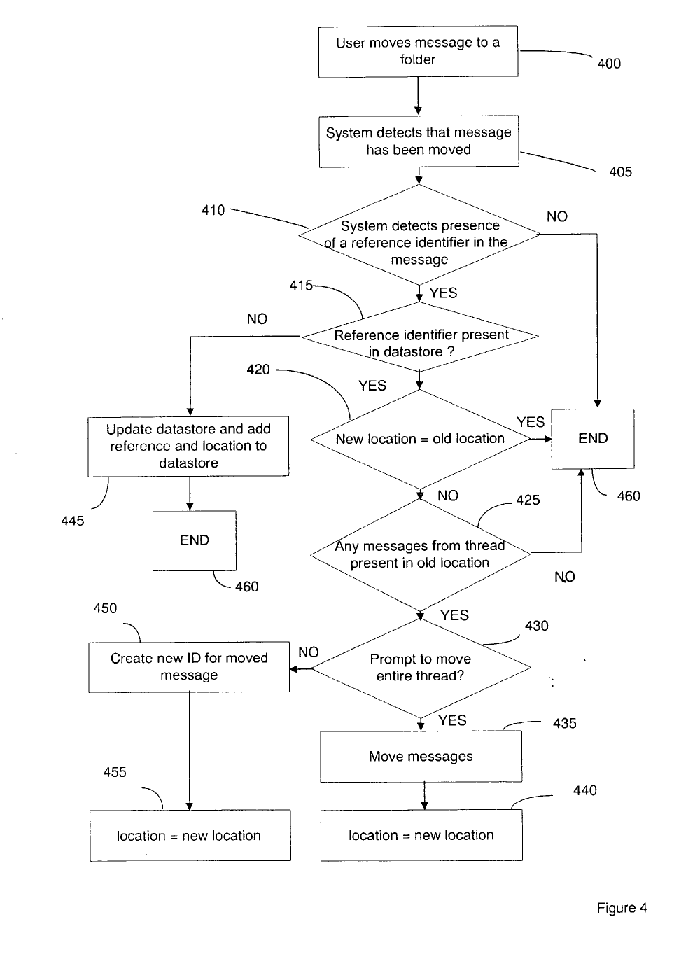

FIG. 4 shows a process flow associated with moving a message from one folder (which may be the inbox) within the message client software package to another folder. A user may move a message to a new folder (Step 400). The system detects that the message has been moved (Step 405) using for example the events feature in Microsoft™ Outlook™, and saves the sender's address and the location so as to save the last filed location for that sender. Having detected the movement of the message, the message is then examined by the system to ascertain whether any identifier is associated with the message (Step 410). If there is no identifier associated with the message then the process terminates (Step 460). If, however, there is an identifier associated with the message then this effects a decision step (Step 415) which will determine whether that identifier is already present within the local datastore. The absence of an identifier within the datastore effects an update of that datastore to reflect the inclusion of the identifier and the location for messages having that identifier (Step 445). The process will then terminate (Step 460).

If an identifier is already present in the datastore then the system is adapted to compare the new moved location to the previously associated location (Step 420). A resulting match will effect a termination of the process (Step 460). If the message identifier had a previously associfated message location within the datastore, and the new location is different, then the system is adapted to confirm whether there are other messages sharing that identifier present in the old location (Step 425). Confirmation that such messages exist will effect a prompting of the user whether they wish to move the entire thread (Step 430). If they effect a confirmatory response then the system is adapted to move the entire thread to the new location (Step 435), and to update the system datastore to reflect that the referenced location is equivalent to the new location (Step 440). If the user decides not to move the entire thread then this implies that the reference identifier previously associated with that thread is redundant for the moved message, it does remain part of the sequence, and a new identifier is created for the moved message (Step 450). The datastore is then updated to reflect that the location referenced to that identifier is the new moved location (Step 455).

This manner of monitoring the movement of messages enables the system and method of the present invention to provide for an efficient manner to update the location of one or more linked message without requiring user intervention to specifically ensure that all messages are updated accurately.

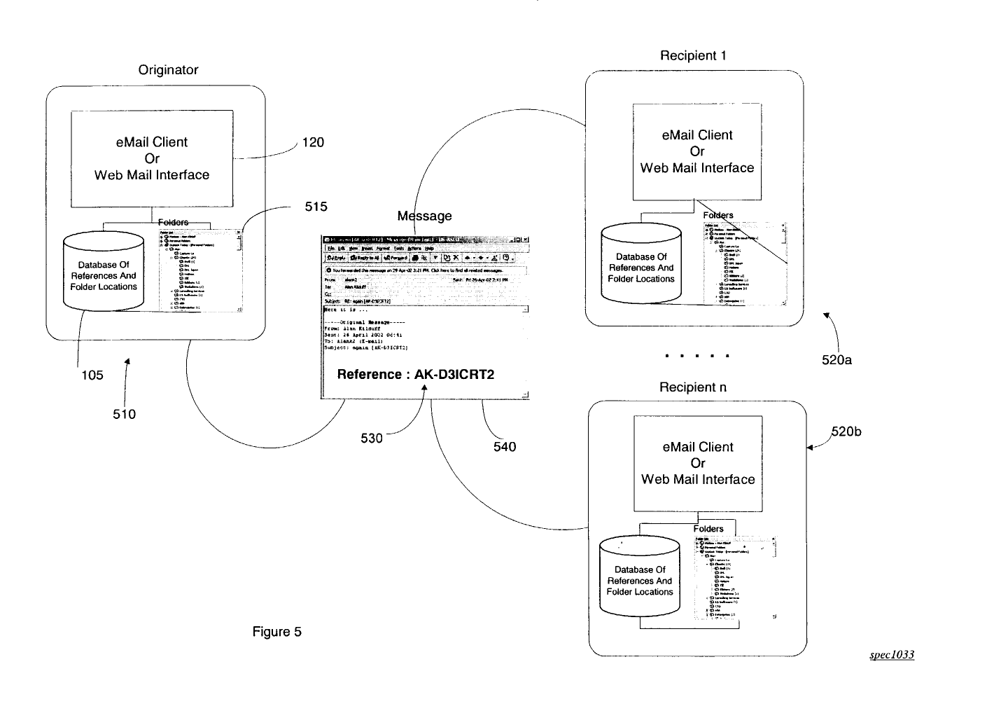

FIG. 5 is a graphical representation illustrating the manner in which a message 540, incorporating an identifier 530 according to the present invention, may be easily routed between a plurality of users, each user utilising the identifier to effect an efficient filing of that message. This network implements a plurality of local systems which were previously described with reference to FIG. 1 and the same reference numerals will be used for equivalent components. Such a network system 500 combining an interface between a plurality of users or clients, provides a utilisation for each client subscribing to the system of a message client 120 such as an e-mail client or web mail interface. Interfaceable to this message client 120 is provided a datastructure or database 105 according to the present invention, which is adapted to provide a link between a message identifier 530 associated with the message 540 and a file location 515 for that message.

It will be appreciated that the purpose of electronic communications is to effect communication between a plurality of users which are shown in FIG. 5 as an originating user 510 and two recipients 520a, 520b. One or more of the recipients may implement the filing system of the present invention, which in the specific example of FIG. 5 is implemented in both. As the originator effected the creation of the first message it has effected the embedding of an identifier 530 in the body of the message, the identifier being linkable to the originator 510. As the recipients will note that the incoming message has an identifier associated therewith, they utilise that identifier for determining the file location at each of their locally stored datastructures. The returned message to the originator will also include the message identifier.

It will be appreciated that although shown for ease of explanation as a communication between two or more users sharing the same technology, that the system of the present invention may be implemented in cross-platform type environments where the technology has enabled the translation of different protocols. For example a first system could be provided for e-mail whereas another could provide a filing facility for mobile telecommunication type interaction. This, it will be appreciated, for example would enable the user to send an e-mail type message to a first user who reads it using a PDA or similar device yet can file it using the identifier created for the e-mail environment.

Accordingly it will be appreciated that the present invention provides a filing system for effecting an efficient and accurate association of related electronic messages that utilises the association of a specific identifier with a message and the utilisation of that identifier with subsequent messages related to that first message. The present invention additionally provides for the linking of that identifier with file storage location so as to enable an efficient filing of associated message.

Although the invention has been described with reference to one specific example of an implementation in an e-mail type environment, it will be appreciated by those skilled in the art that modifications could be made to the description of the hereinbefore described embodiment without departing from the spirit and scope of the invention which is intended only to be limited as may be required in the light of the appended claims.

While the invention has been described with reference to the interaction of specific components and process flow steps it will be appreciated that any sequence or interaction described is of an exemplary embodiment and the present invention should not be limited to such an embodiment.

The words “comprises/comprising” and the words “having/including” when used herein with reference to the present invention are used to specify the presence of stated features, integers, steps or components but does not preclude the presence or addition of one or more other features, integers, steps, components or groups thereof.

1. An electronic message filing system adapted to interface to a messaging system, the filing system having a datastore having a first set of records and a second set of records, each record in the first set being associatable with a specific message identifier, and each corresponding record in the second set providing a location for storage of messages having that message identifier, such that messages received at the messaging system can be interrogated to ascertain a correct location for storing that message.

2. The system as claimed in claim 1 further comprising an identifier creation module, the identifier creation module adapted to effect the creation of a message specific identifier for association with any message that does not have an identifier previously associated therewith.

3. The system as claimed in claim 2 wherein the identifier creation module effects the creation of a message specific identifier for any new message created using the messaging system.

4. The system as claimed in claim 2 wherein the identifier creation module effects the creation of a message specific identifier for any message received at the messaging system not having an identifier associated therewith.

5. The system as claimed in claim 2 wherein the message identifier created for a specific message is created using parameters definable by the characteristics of the created message.

6. The system as claimed in claim 5 wherein the identifier is defined by the user and the time/date of creation of the message.

7. The system as claimed in claim 1 further comprising a search interface adapted to enable a search of all received messages such that any message received at the messaging system not having an identifier associated therewith can be associated with a message previously received from that sender.

8. The system as claimed in claim 1 further comprising a search interface adapted to enable a search of all received messages such that any message received at the messaging system not having an identifier associated therewith can be associated with a location previously associated with that sender.

9. The system as claimed in claim 1 wherein messages created from a message having an identifier are also associated with that same identifier.

10. The system as claimed in claim 1 wherein the records in the second dataset provide an indicator of location of stored messages having specific identifiers.

11. A method of effecting a filing of one or more linkable electronic messages, the method comprising the steps of:
a) providing a first message with an identifier specifically associated with that message,
b) storing that identifier in a first set of records in a datastore,
c) linking that stored identifier with an address for a specific storage location for that first message,
d) associating any subsequent message related to that first message with the same identifier,
e) providing for the filing of the first and subsequent messages in the specific storage location linked to the stored identifier.

12. The method as claimed in claim 11 further comprising the steps, upon receiving a message not having an identifier associated therewith, of:
a) creating a message specific identifier for that message on determination that no identifier is associated therewith,
b) storing the identifier for the received message with the first set of records in the datastore,
c) associating that identifier with a file location.

13. The method as claimed in claim 12 wherein the message specific identifier created for the received message is created using parameters defined by the composition of that message.

14. The method as claimed in claim 12 wherein the step of associating that identifier with a file location comprises the step of:
a) searching received messages for a previously received message from the sender, and on finding the last received and filed message from that sender offering the storage location of that last received message as a storage location for the recently received message.

15. The method as claimed in claim 11 comprising the additional steps, on receiving a message having an identifier associated therewith, of:
a) searching for previously stored messages having that identifier,
b) on identification of previously stored messages, determining a file location for those messages, and
c) effecting a prompting of the user to file the received message in that file location.

16. The method as claimed in claim 11 further comprising the steps, on a subsequent moving of a message from one location to another location, of:
a) determining whether additional messages sharing the same identifier with the moved message are to be moved,
b) if all messages sharing the same identifier are to be moved, updating the file location for all messages having that identifier, or else
c) if all messages sharing the same identifier are not to be moved, creating a new identifier for the moved message such that the moved message is no longer associated with the previous messages.
